(19) United States
(12) Patent Application Publication
(10) Pub. No.: US 2006/0206868 A1
(43) Pub. Date: Sep. 14, 2006

(54) Generic API validation without API specific domain knowledge

(75) Inventors: Thirumalesh K. Bhat, Sammamish, WA (US); Tejas J. Mistry, Sammamish, WA (US)

Correspondence Address: WOLF GREENFIELD (Microsoft Corporation);C/O WOLF, GREENFIELD & SACKS, P.C., FEDERAL RESERVE PLAZA, 600 ATLANTIC AVENUE, BOSTON, MA, 02210-2206, US

(73) Assignee: Microsoft Corporation, Redmond, WA (US)

(21) Appl. No.: 11/078,840

(22) Filed: Mar. 11, 2005

(51) Int. Cl. G06F 9/44

(52) U.S. Cl. 717/124

(57) ABSTRACT

A test application automatically tests exported or user-specified APIs written in native code. In an embodiment of the invention, the tester performs surface-level checks on the APIs through the use of random or directed parameters. The APIs in a DLL are determined in an embodiment of the invention by going through the symbol file which is generated at the time of binary compilation.

### FIELD OF THE INVENTION

This invention pertains generally to computer software development and, more particularly, to the testing and verification of the operation of application programming interfaces (APIs).

### BACKGROUND OF THE INVENTION

In developing software for particular computer systems, e.g., operating systems, developers use specific facilities to access the functionality of the operating system. Typically these facilities are referred to as APIs (application programming interfaces). In order for the developed software to function correctly on the target operating system, it is important that the APIs function correctly.

Typically, in order to test entities such as APIs, a tester will manually write code to expose and test each API. However, there are a number of drawbacks to this type of testing. First and foremost, it is very labor intensive, and as such creates additional costs and inefficiencies in the testing process. Moreover, since human intervention is required, the possibility of errors increases. Finally, a user may not always think to test certain avenues of use of the API, thus often yielding an incomplete test.

Currently, the testing of APIs is thus a balance between cost and completeness, with an attendant risk of errors or omissions regardless of cost. A new testing regimen is needed whereby human intervention is minimized and testing completeness and accuracy are improved.

### BRIEF SUMMARY OF THE INVENTION

In embodiments of the invention, a developer or tester automatically performs invalid parameter tests and stress tests on exported APIs written in native code without requiring specific domain knowledge about the APIs. An example of testable APIs includes those exported in WINDOWS DLLs in the WINDOWS™ brand operating systems from MICROSOFT™ Corporation of Redmond, Wash. In an embodiment of the invention, the developer or tester performs surface-level checks on the APIs which may be stateful or stateless, through the use of random or directed parameters. The APIs in a DLL are determined in an embodiment of the invention by going through the symbol file which is generated at the time of binary compilation.

In an embodiment of the invention, the developer or tester determines vulnerabilities in the APIs to invalid parameter data and exposes potential crashes or memory leaks. This is quite beneficial in that it can be an important way to discover security vulnerabilities in the operating system. Unlike current test tools which are very specific to a set of APIs and directed to functional validation of the APIs, the present invention provides a generic, flexible tool to test a range of APIs without any prior knowledge regarding the APIs.

Additional features and advantages of the invention will be apparent from the following detailed description of illustrative embodiments which proceeds with reference to the accompanying figures.

### BRIEF DESCRIPTION OF THE DRAWINGS

While the appended claims set forth the features of the present invention with particularity, the invention and its advantages are best understood from the following detailed description taken in conjunction with the accompanying drawings, of which:

FIG. 1 is a simplified schematic of an operating environment according to an embodiment of the invention;

FIG. 2 is a flow chart illustrating a process for the extraction of functions from a PDB file according to an embodiment of the invention;

FIG. 3 illustrates a flow chart showing a process of testing APIs according to an embodiment of the invention;

FIG. 4 illustrates a flow chart that is a continuation of the flow chart of FIG. 3, showing a process of testing APIs according to an embodiment of the invention; and

FIG. 5 is a schematic illustration of an example of a suitable computing system environment in which embodiments of the invention may be implemented.

### DETAILED DESCRIPTION OF THE INVENTION

Methods and systems for automated testing of APIs will now be described with respect to various embodiments. The skilled artisan will readily appreciate that the methods and systems described herein are merely exemplary and that variations can be made without departing from the spirit and scope of the invention.

In overview, embodiments of the invention provide a mechanism for quickly testing a wide range of APIs with respect to both stress response and valid and invalid parameter response. The present invention will be more completely understood through the following detailed description, which should be read in conjunction with the attached drawings. In this description, like numbers refer to similar elements within various embodiments of the present invention.

The invention is illustrated as being implemented in a suitable computing environment. Although not required, the invention will be described in the general context of computer-executable instructions, such as procedures, being executed by a personal computer. Generally, procedures include program modules, routines, functions, programs, objects, components, data structures, etc. that perform particular tasks or implement particular abstract data types. Moreover, those skilled in the art will appreciate that the invention may be practiced in a variety of computer system configurations, including hand-held devices, multi-processor systems, and microprocessor-based or programmable consumer electronics devices. The invention may also be practiced in distributed computing environments where tasks are performed by remote processing devices that are linked through a communications network. In a distributed computing environment, program modules may be located in both local and remote memory storage devices. The term computer system may be used to refer to a system of computers such as may be found in a distributed computing environment.

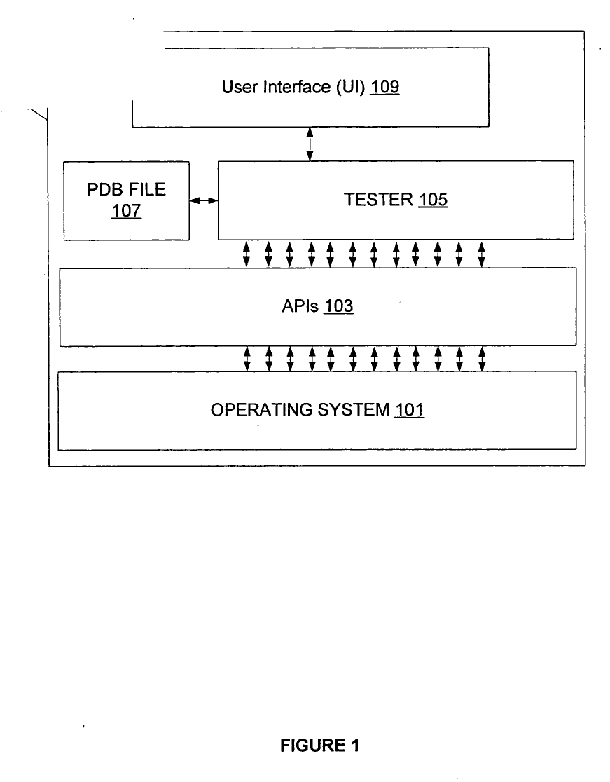

FIG. 1 shows a high level schematic of an operating environment according to an embodiment of the invention. The operating environment 100 may be within a computer such as a personal computer, to be described later, or may be on another type of device, or may be distributed among various computing and/or memory storage devices. As illustrated, the environment 100 comprises a number of intercommunicating elements including an operating system 101 that exposes various APIs 103 to higher level programmatic entities. In embodiments of the invention, the APIs are accessed via a Tester module 105 for purposes of exercising the APIs to determine proper function. In order to exercise the APIs, the Tester 105 requires a certain amount of information regarding which APIs are exposed external to the operating system 101 and so on. Thus, in an embodiment of the invention, the Tester 105 is linked to a program database (PDB) file 107. The PDB file 107 is typically produced during compilation of dynamic linked library (DLL) code and comprises information typically used for debugging.

In overview, before proceeding to a discussion of specific methods, the Tester 105 according to embodiments of the invention extracts an identification of exposed API functions from the PDB 107 so that those functions may be tested. In addition to random testing of functions, a user may also specify specific functions to test via user interface 109 linked to Tester 105. APIs typically support one or both of two types of functions, namely internal and exported. Exported functions are those exposed or made available to other entities outside of the operating system 101. It is exported functions that are of greatest concern since these functions can compromise or be used to compromise the security of the operating system.

The Tester application 105 queries a DLL's PBD file using the Debug Interface Access (DIA) SDK or otherwise and makes a list of all functions available in the DLL that would be of interest for API testing. It will be appreciated that there are other means to glean information from the PDB file or from a similar file. Although the pdb format is not used with respect to all operating systems, it will be appreciated that many such operating systems support formats similar to pdb. It will thus be readily appreciated that symbol extraction and other operations described herein with reference to the pdb format may also be executed with respect to any other such formats and the relevant information can be obtained in such operating environments as well.

According to an embodiment of the invention, a function is considered to be of interest if it has the following properties: (1) Function is an exported function, and (2) Function has one or more parameters. For each function of test interest, the Tester application 105 captures parameter information, including number of parameters and the data type of each parameter. Once the list of functions is available, depending on the setting provided, the application either outputs the list of functions for another application to prune the list or begins testing each function in the list, calling it with random or directed sets of parameter data.

Once a test body of API functions has been identified using the PDB 107, and the list has been pruned in an embodiment of the invention, the Tester 105 proceeds to test the APIs using both random testing with random parameters as well as directed testing using purposefully chosen data parameters in an embodiment of the invention. Examples of the types of parameters that are used for testing include Pointers to data buffers or Pointers to basic types, Pointers to structs, Basic integer data types, Character strings, and Handles or other complex data types.

With respect to Pointers to data buffers or Pointers to basic types, one or more of a number of testing techniques are used in an embodiment of the invention. Example techniques include providing a random memory address that has not actually been allocated, allocating a limited amount of memory and providing pointer to that memory, allocating memory starting at address 0, and providing pointer to that memory, and/or providing other addresses as defined by one or more other programs.

For Pointers to structs, similar testing techniques are used in an embodiment of the invention. Example techniques include providing a random memory address that has not been allocated, determining the size of the struct and allocating the required amount of memory, filling the memory with garbage non-zero data and providing pointer to that memory, allocating memory that is less than what would be required given the size for that struct, providing other addresses as defined by another program calling into this program, and/or allocating memory starting at address 0.

With respect to Basic integer data types, one or more of a number of testing techniques are used in an embodiment of the invention. Example techniques include setting the value as 0, setting the value to the maximum potential real value possible, and/or setting the value at the lowest potential real value possible, or to the highest magnitude negative number if the value is signed.

With respect to Character strings, one or more of a number of testing techniques are used in an embodiment of the invention. Example techniques include providing NULL pointers, providing empty strings, providing extra-long strings (e.g., approx 512 characters in length), providing additional variations for UNICODE or ANSI strings, and/or providing valid strings as inputs.

Finally, with respect to Handles, one or more of a number of testing techniques are used in an embodiment of the invention. Example techniques include providing random parameters for handles and/or providing valid handles as passed in from another program.

An example algorithm for testing a function is as follows:

```
(for each function in function list)
{
  get function address
  get number of parameters
  get parameter data type info
  (for each parameter in the function)
  {
    set up parameter value depending on the type of the parameter
    (if parameter is a numeric or base type)
        assign a random value to the parameter or pick up a value
  provided by another application
    (if parameter is a ptr to a numeric or base type)
        allocate memory for the parameter
        set the ptr parameter to point to the allocated memory
        store random data or data provided by another application in the
      allocated memory
    (if parameter is a ptr to struct)
        determine size of struct
        allocate memory for the parameter equal to size of struct
        set the ptr parameter to point to the allocated memory
        store random data or data provided by another application in the
      allocated memory
    (if parameter is a struct or datatype that requires multiple ’words’ to
  be pushed on stack)
        skip testing this function, as currently not supported
  }
  make function call, using function address and passing parameters
set up in preceding step
  (for each parameter)
    deallocate memory, if memory was allocated
}
```

This process, or another test routine, is repeated for each function in the function list indefinitely or until a predetermined time, such as may be defined by the user, has elapsed.

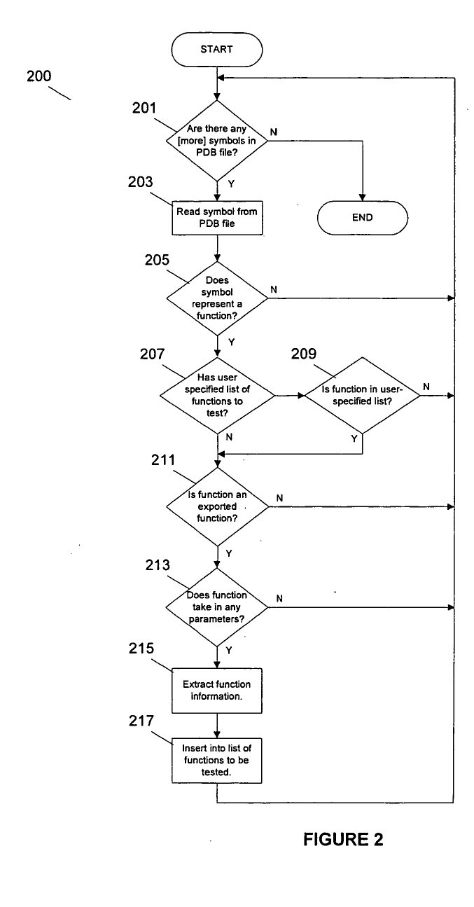

A process for the extraction of functions from the PDB file according to an embodiment of the invention is shown in FIG. 2. The extraction process is executed by an extraction application that is a component of the Tester in an embodiment of the invention. In particular, the process 200 starts at step 201, whereat the extraction application determines whether there are any symbols in the PDB file. To the extent that the process is returning to step 201 after prior processing, the application determines whether any symbols remain in the PDB file. If there are no symbols left in the PDB file, the process ends. Otherwise the process flows to step 203, whereupon the extraction application reads the next symbol from the PDB file.

In step 205, the extraction process determines whether the symbol just read represents a function. If not, the process returns to step 201. Otherwise, the process flows to step 207, where the extraction application determines whether a user has specified a list of functions to test. If the user has specified such a list, the process flows to step 209, whereat the extraction application determines whether the function corresponding to the symbol just read is on the user-supplied list. If not, the process returns to step 201. Otherwise, the process flows to step 211, where the extraction application determines whether the function is an exported function. If not, the process returns to step 201. Otherwise, the process flows to step 213, whereupon the extraction application determines whether the function accepts any parameters.

If the function does not accept any parameters, the process returns to step 201. Otherwise, the process flows to step 215. At step 215, the extraction application extracts the function information for the function from the PDB file. Finally at step 217, the extraction application inserts the function into the list of function to be tested.

In summary then, the extraction application determines what function are represented in the PDB file. If the user has specified a list of functions to test, then the extraction application will compile a list of function information for the functions in the list to the extent that those functions are represented in the PDB file. Otherwise the extraction application will compile a list of function information for all exported functions represented in the PDB file.

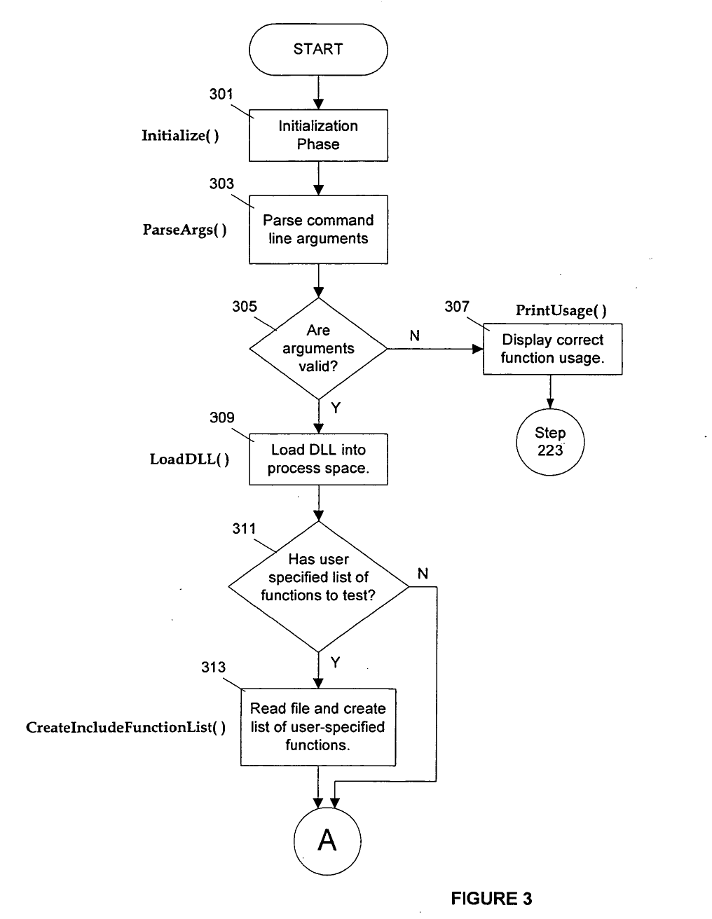

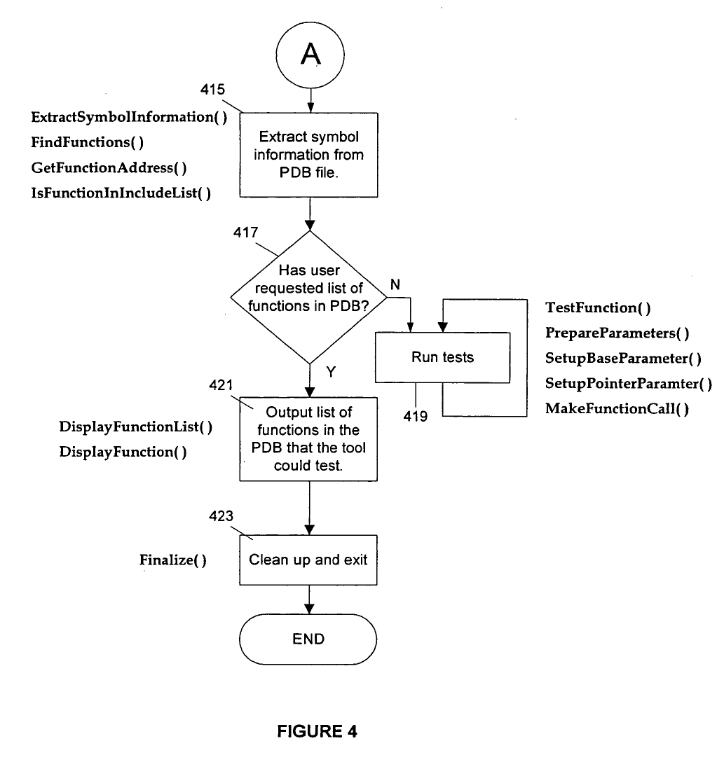

Having discussed the manner in which functions can be identified and extracted, a process of testing the various functions will now be described by reference to FIGS. 3 and 4. In step 301 of the process, the test application initializes in a manner well understood by those of skill in the art of computer science in order to begin operation, including presentation of a command line interface in an embodiment of the invention. At step 303, the test application parses any command line arguments and flows to step 305. At step 305, the test application determines whether the command line arguments are valid. If it is determined at step 305 that the command line arguments are not valid, then the process flows to step 307, whereat the test application displays the correct function usage to the user via the user interface.

If it is determined at step 305 that the command line arguments are indeed valid, then the process flows to step 309, whereat the test application loads the DLL in question into its process space. Next, at step 311, the test application determines whether the user has specified a list of functions to test. If the user has specified a list of functions to test, then the process flows to step 313, whereat the test application reads the file and creates a list of user-specified functions. Subsequently the process flows to node A of the flow chart of FIG. 4. If it is determined in step 311 that the user has not specified a list of functions to test, then the process flows directly to node A of the flow chart of FIG. 4.

The flow chart of FIG. 4 illustrates a continuation of the process described in FIG. 3. At step 415, the test application extracts symbol information from the PDB file. Each entity in a binary (DLL) such as a function, parameter, variable, etc, is represented in the PDB as an object (or ‘symbol’). The PDB file holds detailed information for each of these objects. A process for such extraction was illustrated with respect to FIG. 2. At step 417, the test application determines whether the user has requested to receive a listing of the functions extracted from the PDB file. For example, a user may request to see which functions are present in the DLL as a prelude to specifying that certain specific functions should be tested. If it is determined at step 417 that the user has not requested to receive a listing of the functions extracted from the PDB file, then the process flows to step 419. At step 419, the test application tests the identified functions of the DLL.

If at step 417 the test application determines that the user has requested to receive a listing of the functions extracted from the PDB file, then the process flows to step 421. At step 421 the test application outputs to the user interface a list of functions that can be tested based on the information contained in the PDB file. Finally, at step 423, the test application cleans up and exits and the process ends.

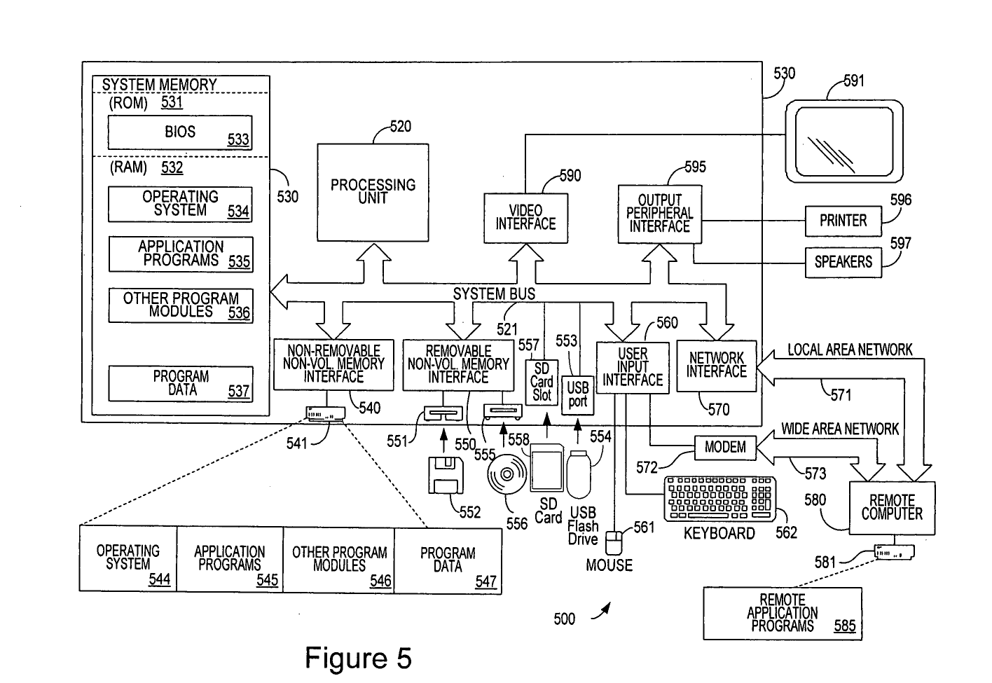

As noted above, the test application and other components of the invention described herein operate on one or more computing devices. FIG. 5 illustrates an example of a suitable computing system environment 500 in which the invention may be implemented. The computing system environment 500 is only one example of a suitable computing environment and is not intended to suggest any limitation as to the scope of use or functionality of the invention. Nor should the computing environment 500 be interpreted as having any dependency or requirement relating to any one or combination of components illustrated in the exemplary operating environment 500. Although at least one embodiment of the invention does include each component illustrated in the exemplary operating environment 500, another more typical embodiment of the invention excludes some or all non-essential components, for example, input/output devices other than those required for network communications.

That said, one example system for implementing the invention includes a general purpose computing device in the form of a computer 510. Components of the computer 510 may include, but are not limited to, a processing unit 520, a system memory 530, and a system bus 521 that couples various system components including the system memory to the processing unit 520. The system bus 521 may be any of several types of bus structures including a memory bus or memory controller, a peripheral bus, and a local bus using any of a variety of bus architectures.

The computer 510 typically includes a variety of computer-readable media. Computer-readable media can be any available media that can be accessed by the computer 510 and include both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, optical disk storage, magnetic cassettes, magnetic tape, magnetic disk storage or other magnetic storage devices, or any other medium which can be used to store the desired information and which can be accessed by the computer 510. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above are included within the scope of computer-readable media.

The system memory 530 includes computer storage media in the form of volatile and/or nonvolatile memory such as read only memory (ROM) 531 and random access memory (RAM) 532. By way of example, and not limitation, FIG. 5 illustrates operating system 534, application programs 535, other program modules 536 and program data 537.

The computer 510 may also include other removable and non-removable, volatile and nonvolatile computer storage media. By way of example only, FIG. 5 illustrates a hard disk drive 541 that reads from or writes to non-removable, nonvolatile magnetic media, a magnetic disk drive 551 that reads from or writes to a removable, nonvolatile magnetic disk 552, and an optical disk drive 555 that reads from or writes to a removable, nonvolatile optical disk 556 such as a CDROM. Other computer storage media that can be used in the exemplary operating environment include, but are not limited to, magnetic tape cassettes, flash memory cards, DVDs, digital video tape, solid state RAM, solid state ROM, and the like. The hard disk drive 541 is typically connected to the system bus 521 through a non-removable memory interface such as interface 540, and magnetic disk drive 551 and optical disk drive 555 are typically connected to the system bus 521 by a removable memory interface, such as interface 550.

The computer system may include interfaces for additional types of removable non-volatile storage devices. For instance, the computer may have a USB port 553 that can accept a USB flash drive (UFD) 554, or a SD card slot 557 that can accept a Secure Digital (SD) memory card 558. A USB flash drive is a flash memory device that is fitted with a USB connector that can be inserted into a USB port on various computing devices. A SD memory card is a stamp-sized flash memory device. Both the USB flash drive and SD card offer high storage capacity in a small package and high data transfer rates. Other types of removable storage media may also be used for implementing the invention.

The drives and their associated computer storage media, discussed above and illustrated in FIG. 5, provide storage of computer-readable instructions, data structures, program modules and other data for the computer 510. In FIG. 5, for example, hard disk drive 541 is illustrated as storing an operating system 544, application programs 545, other program modules 546 and program data 547. Note that these components can either be the same as or different from operating system 534, application programs 535, other program modules 536, and program data 537. Operating system 544, application programs 545, other program modules 546, and program data 547 are given different numbers herein to illustrate that, at a minimum, they are different copies. A user may enter commands and information into the computer 510 through input devices such as a tablet, or electronic digitizer, 564, a microphone 563, a keyboard 562 and pointing device 561, commonly referred to as a mouse, trackball or touch pad. These and other input devices are often connected to the processing unit 520 through a user input interface 560 that is coupled to the system bus, but may be connected by other interface and bus structures, such as a parallel port, game port or a universal serial bus (USB). A monitor 591 or other type of display device is also connected to the system bus 521 by way of an interface, such as a video interface 590. The monitor 591 may also be integrated with a touch-screen panel or the like. Note that the monitor and/or touch screen panel can be physically coupled to a housing in which the computing device 510 is incorporated, such as in a tablet-type personal computer. In addition, computers such as the computing device 510 may also include other peripheral output devices such as speakers 597 and printer 596, which may be connected through an output peripheral interface 594 or the like.

The computer 510 preferably operates or is adaptable to operate in a networked environment using logical connections to one or more remote computers, such as a remote computer 580. The remote computer 580 may be a personal computer, a server, a router, a peer device or other network node, and typically includes some or all of the elements described above relative to the computer 510, although only a memory storage device 581 has been illustrated in FIG. 5. The logical connections depicted in FIG. 5 include a LAN 571 and a WAN 573, but may also include other networks. For example, in the present invention, the computer 510 may comprise the source machine from which data is being migrated, and the remote computer 580 may comprise the destination machine, e.g., a thin client device. Note however that source and destination machines need not be initially connected by a network or otherwise, but instead, data may be migrated by way of any media capable of being written by the source platform and read by the destination platform or platforms. For example, one non-limiting instance of such a medium is a portable flash memory medium.

When used in a LAN environment, the computer 510 is connectable to the LAN 571 through a network interface or adapter 570. The computer 510 may also include a modem 572 or other means for establishing communications over the WAN 573. The modem 572, which may be internal or external, may be connected to the system bus 521 by way of the user input interface 560 or other appropriate mechanism. In a networked environment, program modules depicted relative to the computer 510, or portions thereof, may be stored in the remote memory storage device. By way of example, and not limitation, FIG. 5 illustrates remote application programs 585 as residing on memory device 581. It will be appreciated that the network connections shown are exemplary and other means of establishing a communications link between the computers may be used.

It will be appreciated that a new and useful system for automated API testing has been described. Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. For example, although the term “list” is used herein, it will be appreciated that a listing is not required to plural but comprises one or more items. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

All references, including publications, patent applications, patents and appendices, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Any recitation of ranges of values herein is merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

What is claimed is:

1. A method of testing an application programming interface to an operating system for use in a computing system, the application programming interface comprising one or more functions, the method comprising:
identifying the one or more functions of the application programming interface by automatic extraction from a file associated with the application programming interface; and
automatically testing at least a portion of the one or more functions of the application programming interface by calling the portion of the one or more functions and supplying parameters thereto.

2. The method according to claim 1, wherein identifying the one or more functions of the application programming interface by automatic extraction from a file associated with the application programming interface further comprises reading a program database file associated with the application programming interface.

3. The method according to claim 2, wherein the file associated with the application programming interface is a program database file comprising symbols, and wherein automatic extraction from a file associated with the application programming interface further comprises reading one or more symbols from the program database file and determining that the one or more symbols identify one or more functions of the application programming interface.

4. The method according to claim 3, wherein a user of the computing system has provided a list of functions, the method further comprising:
determining that a function of the application programming interface identified by the one or more symbols is on the user-supplied list of functions; and
determining that such function is an exported function.

5. The method according to claim 4, further comprising determining one or more input parameters for the exported function.

6. The method according to claim 5, further comprising listing the exported function on a list of functions to be tested.

7. The method according to claim 6, further comprising testing the exported function by calling the function and supplying one or more input parameters to the function.

8. The method according to claim 7, wherein supplying one or more input parameters to the function comprises supplying a parameter having a randomly selected value.

9. The method according to claim 7, wherein supplying one or more input parameters to the function comprises supplying a parameter having a value selected from a known range of valid values for the function.

10. A computer-readable medium having thereon computer-readable instructions for performing a method of testing an application programming interface to an operating system for use in a computing system, the application programming interface comprising one or more functions, the instructions comprising instructions for:
identifying the one or more functions of the application programming interface by automatic extraction from a file associated with the application programming interface; and
automatically testing at least a portion of the one or more functions of the application programming interface by calling the portion of the one or more functions and supplying parameters thereto.

11. The computer-readable medium according to claim 10, wherein the instructions for identifying the one or more functions of the application programming interface by automatic extraction from a file associated with the application programming interface further comprises instructions for reading a program database file associated with the application programming interface.

12. The computer-readable medium according to claim 11, wherein the file associated with the application programming interface is a program database file comprising symbols, and wherein automatic extraction from a file associated with the application programming interface further comprises reading one or more symbols from the program database file and determining that the one or more symbols identify one or more functions of the application programming interface.

13. The computer-readable medium according to claim 12, wherein a user of the computing system has provided a list of functions, the instructions further comprising instructions for:
determining that a function of the application programming interface identified by the one or more symbols is on the user-supplied list of functions; and
determining that such function is an exported function.

14. The computer-readable medium according to claim 13, further comprising instructions for determining one or more input parameters for the exported function.

15. The computer-readable medium according to claim 14, further comprising instructions for listing the exported function on a list of functions to be tested.

16. The computer-readable medium according to claim 15, further comprising instructions for testing the exported function by calling the function and supplying one or more input parameters to the function.

17. The computer-readable medium according to claim 16, wherein supplying one or more input parameters to the function comprises supplying a parameter having a randomly selected value.

18. The computer-readable medium according to claim 16, wherein supplying one or more input parameters to the function comprises supplying a parameter having a value selected from a known range of valid values for the function.

19. A method of testing an application programming interface for use interfacing to a computer operating system, the method comprising:
compiling source code for the application programming interface;
during compilation of the source code, producing a program database file for the application programming interface;
extracting from the program database file an identification of at least one function of the application programming interface, the function accepting one or more input parameters; and
testing the application programming interface by calling the at least one function and supplying it with the one or more input parameters.

20. The method according to claim 19, wherein the one or more input parameters are selected from the group consisting of pointers to data buffers, pointers to basic types, pointers to structs, basic integer data types, character strings, and handles.
